(19) United States
(12) Patent Application Publication
(10) Pub. No.: US 2025/0072321 A1
(43) Pub. Date: Mar. 6, 2025

(54) WALK-BEHIND POWER TOOL

(71) Applicant: Nanjing Chervon Industry Co., Ltd., Nanjing (CN)

(72) Inventors: Tianwei Niu, Nanjing (CN); Qi Zhang, Nanjing (CN); Renzhi Zhu, Nanjing (CN)

(21) Appl. No.: 18/805,620

(22) Filed: Aug. 15, 2024

(30) Foreign Application Priority Data
Aug. 31, 2023 (CN) 202311120477.9
Aug. 31, 2023 (CN) 202322370263.9

(51) Int. Cl. A01D 34/68; A01D 34/81; A01D 101/00

(52) U.S. Cl. CPC A01D 34/6806; A01D 34/81; A01D 2101/00

(57) ABSTRACT

A walk-behind power tool includes a working assembly, a body, a handle device, and an energy device. The working assembly includes a working member and a motor configured to drive the working member. The body is configured to accommodate the working assembly. The energy device is configured to provide energy for the motor. The body includes a coupling portion configured to accommodate the energy device and a storage portion configured to store an article. The body has a foremost end of the body, and at least part of the coupling portion is disposed between the foremost end of the body and the storage portion. A projection of the storage portion on the ground is defined as a first projection, a projection of the working member in rotation on the ground is defined as a second projection, and at least part of the first projection overlaps the second projection.

### RELATED APPLICATION INFORMATION

This application claims the benefit under 35 U.S.C. § 119 (a) of Chinese Patent Application No. 202311120477.9, filed on Aug. 31, 2023, and Chinese Patent Application No. 202322370263.9, filed on Aug. 31, 2023, which applications are incorporated herein by reference in their entireties.

### TECHNICAL FIELD

The present application relates to a power tool and, in particular, to a walk-behind power tool.

### BACKGROUND

A walk-behind power tool in the related art, such as a mower, includes a motor and a cutting blade. The motor is used for driving the cutting blade to rotate to implement cutting, and the energy device is used for supplying power to the motor.

The cutting blade is generally disposed on a middle portion of a machine body, and walking wheels are disposed at the front and rear ends of the machine body. To shorten the distance between the energy device and the motor, the energy device is generally disposed on the middle portion of the machine body so that the motor is located below the energy device. A grass basket of the mower is generally located on a rear portion of the machine body, and the energy device is disposed on the middle portion of the machine body. When the grass basket is filled with grass, the center of gravity of the whole machine is backward, causing a poor balance and a risk of head lifting. Additionally, since the energy device is disposed on the middle portion of the machine body, space in the machine body is wasted and cannot be effectively utilized.

This part provides background information related to the present application, and the background information is not necessarily the existing art.

### SUMMARY

A walk-behind power tool includes a working assembly including a working member and a motor configured to drive the working member to rotate; a body configured to accommodate at least part of the working assembly; a handle device connected to the body; and an energy device configured to provide energy for the motor. The body includes a coupling portion configured to accommodate the energy device and a storage portion configured to store an article. The body has a foremost end of the body, and at least part of the coupling portion is disposed between the foremost end of the body and the storage portion. A projection of the storage portion on the ground is defined as a first projection, a projection of the working member in rotation on the ground is defined as a second projection, and at least part of the first projection overlaps the second projection.

In some examples, an overlapping portion between the first projection and the second projection is defined as a third projection, and the area ratio of the third projection to the first projection is greater than or equal to 0.5 and less than or equal to 1.

In some examples, a projection of the coupling portion on the ground is defined as a fourth projection, and the area ratio of the fourth projection to the first projection is greater than or equal to 0.3 and less than or equal to 2.

In some examples, an overlapping portion between the fourth projection and the second projection is defined as a fifth projection, and the area ratio of the fifth projection to the second projection is greater than or equal to 0 and less than or equal to 0.2.

In some examples, at least part of the storage portion has a continuous and smooth bottom surface, a projection of the bottom surface on the ground is defined as a sixth projection, and the area ratio of the sixth projection to the second projection is greater than or equal to 0.3 and less than or equal to 0.9.

In some examples, the body includes a deck and a machine cover disposed at least partially over the deck.

In some examples, the machine cover is formed with the storage portion.

In some examples, the machine cover is formed with the coupling portion.

In some examples, the storage portion is formed with an accommodation space, the accommodation space has a maximum water storage depth, and the ratio of the maximum water storage depth to the length of a longest part of the first projection is greater than or equal to 0.1 and less than or equal to 0.3.

In some examples, the storage portion is formed with an accommodation space, the accommodation space has a maximum water storage depth, and the maximum water storage depth is greater than or equal to 30 mm and less than or equal to 200 mm.

In some examples, the energy device has a foremost end of the energy device, and the distance between the foremost end of the energy device and the foremost end of the body is greater than or equal to 50 mm and less than or equal to 250 mm.

In some examples, the motor is configured to rotate around a motor axis, the energy device has a rearmost end of the energy device, the rearmost end of the energy device is located before the motor axis, and the distance between the rearmost end of the energy device and the motor axis is greater than or equal to 5 mm and less than or equal to 200 mm.

In some examples, at least part of the storage portion is movable.

In some examples, the storage portion includes at least two storage regions, and adjacent storage regions are separated by a barrier portion.

In some examples, the storage portion has a rearmost end of the storage portion, and a projection of the rearmost end of the storage portion on the ground is located behind the second projection.

In some examples, an upper cover is disposed over the storage portion, and the upper cover enables an accommodation space of the storage portion to be opened or closed.

In some examples, at least part of the storage portion includes a drain channel configured to guide water in the storage portion to flow out.

A walk-behind power tool includes a working assembly including a working member and a motor configured to drive the working member to rotate; a body configured to accommodate at least part of the working assembly; a handle device connected to the body; and an energy device configured to provide energy for the motor. The body includes a coupling portion configured to accommodate the energy device and a storage portion configured to store an article. The body has a foremost end of the body, and in a front and rear direction, the foremost end of the body, the storage portion, and the coupling portion are arranged in sequence. Projections of the storage portion and the motor on the ground at least partially overlap.

In some examples, the length of the storage portion in the front and rear direction is greater than or equal to 200 mm and less than or equal to 500 mm.

In some examples, the length of the storage portion in a left and right direction is greater than or equal to 150 mm and less than or equal to 400 mm.

### BRIEF DESCRIPTION OF THE DRAWINGS

FIG. 1 is a structural view of a mower according to the present application;

FIG. 2 is a side view of a mower according to the present application;

FIG. 3 is a top view of a mower according to the present application;

FIG. 4 is an exploded view one of a mower according to the present application;

FIG. 5 is an exploded view two of a mower according to the present application;

FIG. 6 is a front view of part of the structure of a mower according to the present application;

FIG. 7 is a sectional view of FIG. 6 taken along A-A;

FIG. 8 is a schematic view of projections of a mower according to the present application;

FIG. 9 is a bottom view of part of the structure of a mower according to the present application;

FIG. 10 is a top view of part of the structure of a mower according to the present application;

FIG. 11 is an exploded view of another mower according to the present application;

FIG. 12 is an exploded view of another mower with a rotatable storage portion according to the present application;

FIG. 13 is a top view of another mower according to the present application;

FIG. 14 is a top view of another mower with a rotatable storage portion according to the present application; and

FIG. 15 is a top view of a storage portion of another mower according to the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

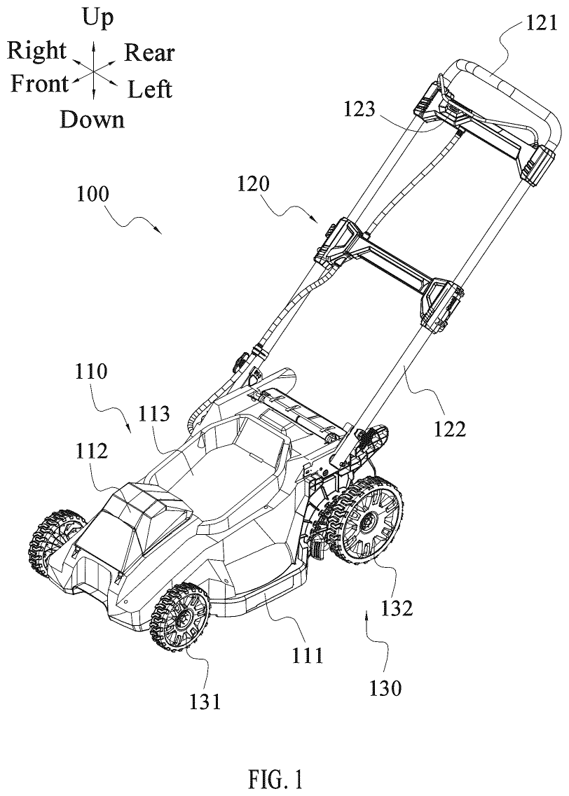

A walk-behind power tool shown in FIG. 1 is used for a user to cut grass in a lawn, such as a lawn of a garden or a golf course. The grass in the lawn requires regular care and thus needs to be often cut with the walk-behind power tool. In this example, the walk-behind power tool is a mower 100. When the user operates the mower 100, the user stands behind the mower 100 to push the mower 100 to walk on the ground.

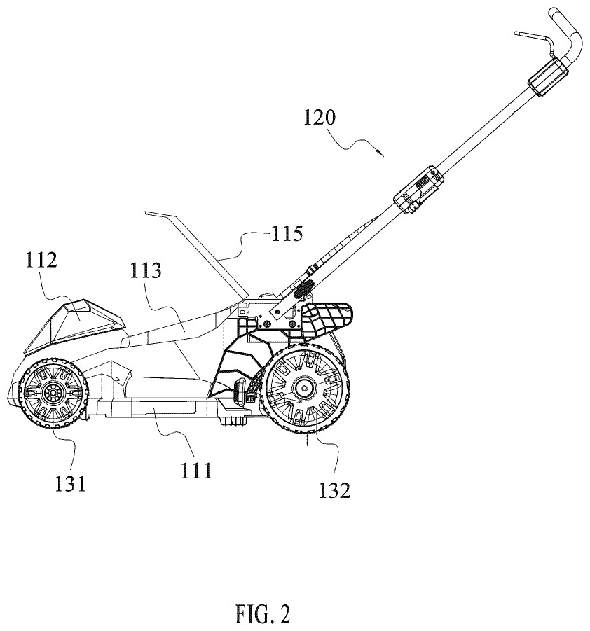

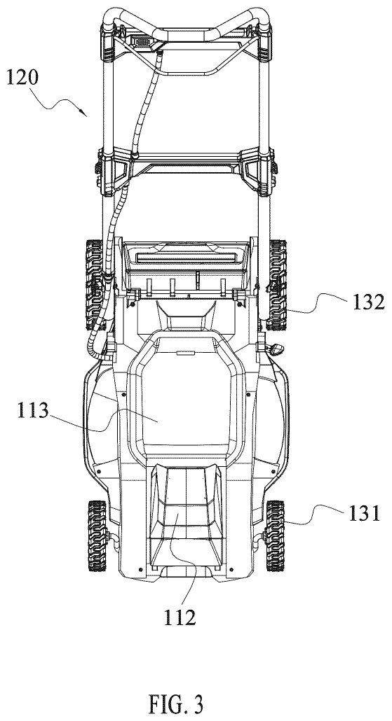

As shown in FIGS. 1 to 3, the mower 100 includes a body 110, a handle device 120, and a walking assembly 130.

The handle device 120 is connected to the body 110. The mower 100 has a moving state in which the body 110 and at least part of the handle device 120 move relatively. In a process of the body 110 and at least part of the handle device 120 moving relatively, the mower 100 is in the moving state. In this example, the handle device 120 may be pivotally connected to the body 110. In the moving state, the handle device 120 rotates relative to the body 110. In some examples, the handle device 120 is fixedly connected to the body 110. The handle device 120 is configured for the user to operate. The handle device 120 includes a holding end 121 and connecting rods 122, the holding end 121 is used for the user to hold to push or support the mower 100, and the connecting rods 122 connect the holding end 121 to the body 110. The handle device 120 further includes a trigger 123 disposed on the holding end 121. The trigger 123 is for the user to press to control the mower 100 to mow the grass.

The walking assembly 130 includes two front walking wheels 131 and two rear walking wheels 132. The walking assembly 130 can at least drive the mower 100 to advance, retreat, and turn on the ground. The walking assembly 130 supports the body 110 and the handle device 120.

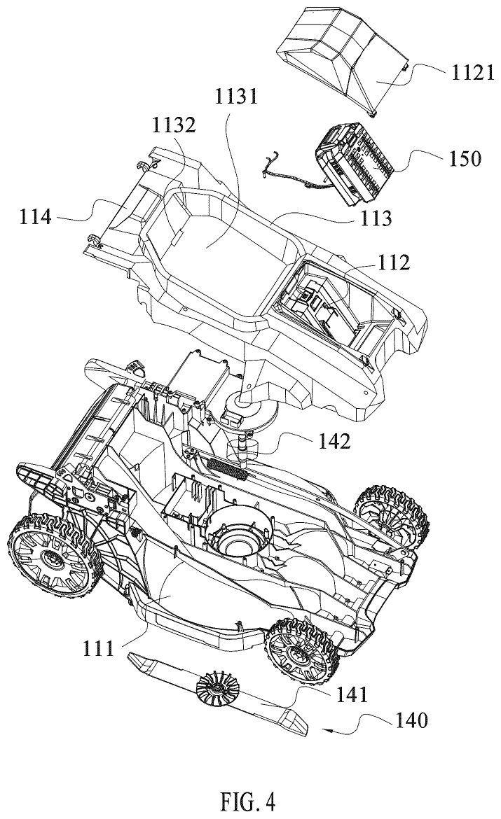

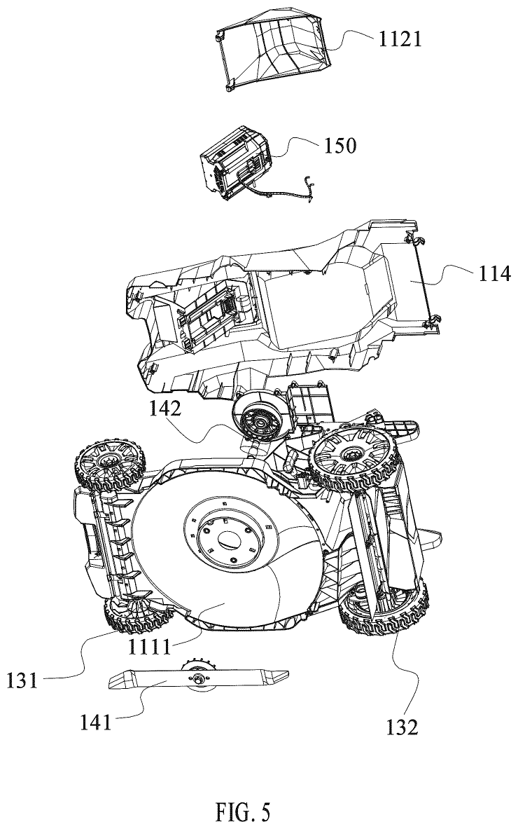

As shown in FIGS. 4 and 5, the mower 100 further includes a working assembly 140. The body 110 accommodates at least part of the working assembly 140. The working assembly 140 includes a working member 141 and a motor 142, and the motor 142 is configured to drive the working member 141 to move. The body 110 includes a deck 111. The deck 111 is formed with an accommodation space 1111 for accommodating at least part of the working member 141. The accommodation space 1111 is open downward, and the working member 141 is disposed in the accommodation space 1111. The motor 142 is mounted to the deck 111, and the working member 141 is mounted to the motor 142 to be driven by the motor 142. The working member 141 may be a blade. One or more blades may be provided. The motor 142 may be an electric motor. The electric motor drives the blade to rotate at a high speed to mow the grass.

The body 110 supports the working assembly 140. The body 110 connects the walking assembly 130, the working assembly 140, and the handle device 120 into a whole. The body 110 further includes a coupling portion 112 configured to accommodate an energy device 150. The energy device 150 is a battery pack, and the battery pack is used for providing power for the mower 100. Specifically, the energy device 150 is configured to provide energy for the motor 142. In other examples, the coupling portion 112 may be connected to a cable, and the cable may be connected to a mains electricity grid. In other examples, the coupling portion 112 may be connected to another energy device. For example, the coupling portion 112 may be connected to a fuel tank, and fuel in the fuel tank may provide energy for the mower 100.

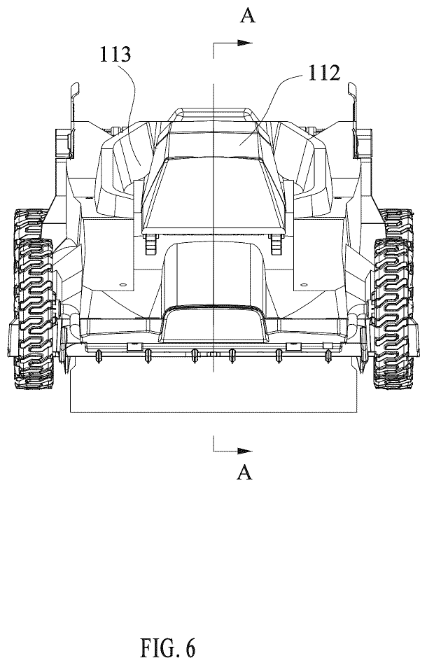

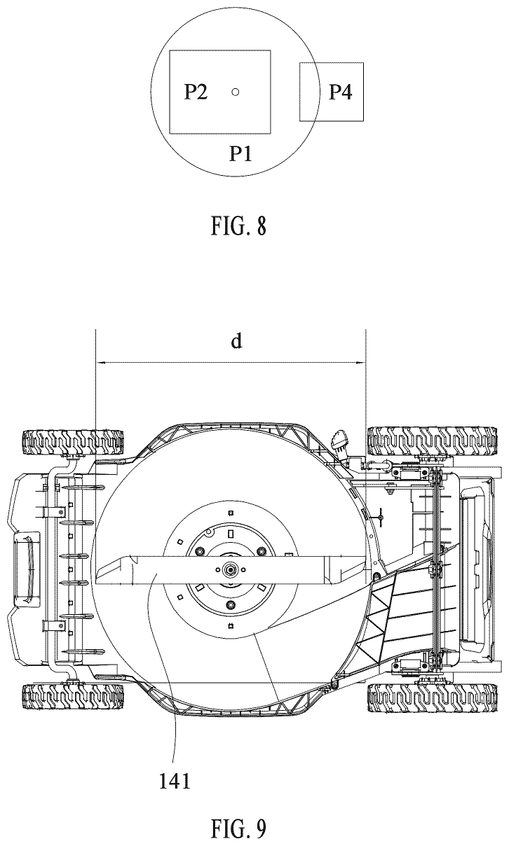

Referring to FIGS. 1 to 8, the body 110 further includes a storage portion 113 configured to store an article, the body 110 has a foremost end 110a of the body, and at least part of the coupling portion 112 is disposed between the foremost end 110a of the body and the storage portion 113. In a front and rear direction, the foremost end of the body, the coupling portion, and the storage portion are arranged in sequence. A projection of the storage portion 113 on the ground is defined as a first projection P1, a projection of the working member 141 in rotation on the ground is defined as a second projection P2, and at least part of the first projection P1 overlaps the second projection P2. The projections of the storage portion 113 and the working member 141 in rotation on the ground at least partially overlap. Projections of the storage portion 113 and the motor 142 on the ground at least partially overlap.

The storage portion 113 is disposed so that a storage space is added to allow the user to place articles, tools, garbage, and the like. The projection of the storage portion 113 on the ground is the first projection P1, the projection of the working member 141 in rotation on the ground is the second projection P2, and at least part of the first projection P1 overlaps the second projection P2. Thus, at least part of the storage portion 113 is disposed on a middle portion of the body 110. At least part of the coupling portion 112 is disposed between the foremost end 110a of the body and the storage portion 113 so that the battery pack is placed forward, and the center of gravity of the whole machine moves forward. Even if a grass basket is filled with grass, a balance can be ensured.

An overlapping portion between the first projection P1 and the second projection P2 is defined as a third projection P3, and the area ratio of the third projection P3 to the first projection P1 is greater than or equal to 0.5 and less than or equal to 1. It is ensured that most of the storage portion 113 is disposed on the middle portion of the body 110, ensuring the balance of the whole machine. In some examples, the area ratio of the third projection P3 to the first projection P1 equals 0.5, 0.6, 0.7, 0.8, 0.9, or 1.

A projection of the coupling portion 112 on the ground is defined as a fourth projection

P4, and the area ratio of the fourth projection P4 to the first projection P1 is greater than or equal to 0.3 and less than or equal to 2. In some examples, the area ratio of the fourth projection P4 to the first projection P1 is greater than or equal to 0.8 and less than or equal to 1.5. In some examples, the area ratio of the fourth projection P4 to the first projection P1 equals 0.3, 0.5, 0.8, 1, 1.2, 1.5, 1.8, or 2.

An overlapping portion between the fourth projection P4 and the second projection P2 is defined as a fifth projection P5, and the area ratio of the fifth projection P5 to the second projection P2 is greater than or equal to 0 and less than or equal to 0.2. In some examples, the area ratio of the fifth projection P5 to the second projection P2 equals 0, 0.1, or 0.2.

At least part of the storage portion 113 has a continuous and smooth bottom surface 1131, a projection of the bottom surface 1131 on the ground is defined as a sixth projection P6, and the area ratio of the sixth projection P6 to the second projection P2 is greater than or equal to 0.3 and less than or equal to 0.9. In some examples, the area ratio of the sixth projection P6 to the second projection P2 equals 0.3, 0.4, 0.5, 0.6, 0.7, 0.8, or 0.9. In this example, the bottom surface 1131 of the whole storage portion 113 is continuous and smooth. The smooth bottom surface 1131 is pleasing and allows the user to conveniently place an article with a relatively large volume, and the stored article can be supported by the bottom surface 1131 and has high stability. It is to be noted that the continuous and smooth bottom surface 1131 is used for representing a basic shape of the bottom surface 1131 and not intended to limit the roughness of the bottom surface 1131. In some examples, granular protrusions or a rubber pad is disposed on the bottom surface 1131 to increase a friction force exerted by the bottom surface 1131 on the stored article.

In the drawings, P1 represents the first projection, P2 represents the second projection, P3 represents the third projection, P4 represents the fourth projection, P5 represents the fifth projection, and P6 represents the sixth projection.

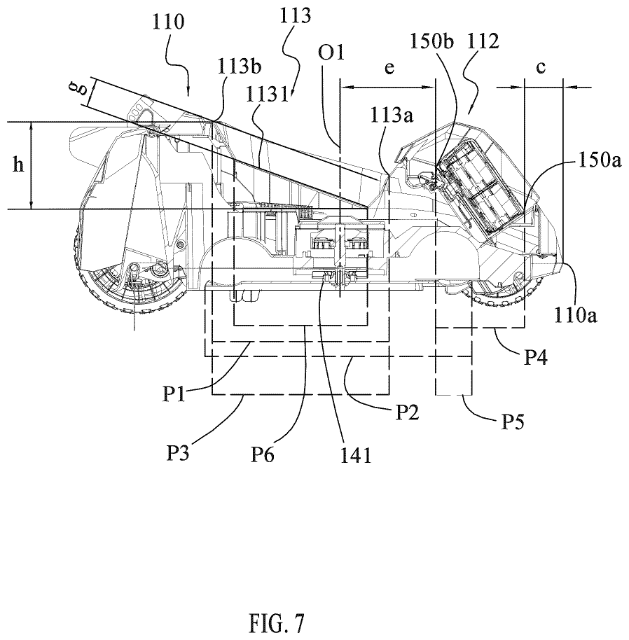

As shown in FIGS. 7 and 9, since the working member 141 is driven by the motor 142 to rotate, the second projection P2 is basically circular. The diameter of the second projection P2 is greater than or equal to 350 mm and less than or equal to 600 mm. In FIG. 9, d represents a maximum diameter of the working member 141, that is, the diameter of the second projection P2. Additionally, the first projection P1 may be circular, rectangular, or in another shape, so the third projection P3 may have an irregular shape.

The storage portion 113 can store an article. Therefore, the storage portion 113 is formed with an accommodation space, and the article can be placed in the accommodation space. The accommodation space has a maximum water storage depth g. In FIG. 7, g represents the maximum water storage depth of the accommodation space. The maximum water storage depth g of the accommodation space is a maximum depth of water after the accommodation space is filled with a maximum volume of water that the accommodation space can accommodate. It is to be noted that when the maximum water storage depth is measured, an angle at which the storage portion 113 is placed is not limited. That is to say, the storage portion 113 may have the maximum water storage depth g when located obliquely, horizontally, or at any other position. The first projection P1 may be circular, rectangular, or in another shape, and the bottom surface 1131 of the accommodation space may be a planar surface, a curved surface, or an uneven surface. The ratio of the maximum water storage depth g to the length of a longest part of the first projection P1 is greater than or equal to 0.1 and less than or equal to 0.3. In some examples, the ratio of the maximum water storage depth g to the length of the longest part of the first projection P1 equals 0.1, 0.2, or 0.3. The ratio of the maximum water storage depth g to the length of the longest part of the first projection is relatively small, the accommodation space has a relatively large storage area and a relatively shallow storage depth so that the user can conveniently place the article with a relatively large volume, and the bottom surface 1131 is relatively close to the user so that the user can conveniently fetch the article without squatting.

The maximum water storage depth g of the accommodation space is greater than or equal to 30 mm and less than or equal to 200 mm. In some examples, the maximum water storage depth g of the accommodation space is greater than or equal to 50 mm and less than or equal to 150 mm. In some examples, the maximum water storage depth g of the accommodation space is greater than or equal to 100 mm and less than or equal to 120 mm.

The accommodation space has a vertical height h. In FIG. 7, h represents the vertical height of the accommodation space. The vertical height h of the accommodation space is the vertical distance from a highest point of an upper edge of the accommodation space to a lowest point of the bottom surface 1131 of the accommodation space in a vertical direction. The vertical height h of the accommodation space is greater than or equal to 20 mm and less than or equal to 300 mm. In some examples, the vertical height h of the accommodation space is greater than or equal to 50 mm and less than or equal to 250 mm. In some examples, the vertical height h of the accommodation space is greater than or equal to 100 mm and less than or equal to 200 mm.

The storage portion 113 has a foremost end 113a of the storage portion and a rearmost end 113b of the storage portion, the distance L between the foremost end 113a of the storage portion and the rearmost end 113b of the storage portion is the length of the storage portion 113, and a horizontal distance a between the foremost end 113a of the storage portion and the rearmost end 113b of the storage portion is the length of the second projection P2 in the front and rear direction. It is to be understood that the storage portion 113 may be horizontally placed on the body 110 or may be obliquely placed to make full use of space. Therefore, the length L of the storage portion 113 is greater than or equal to the length a of the second projection in the front and rear direction.

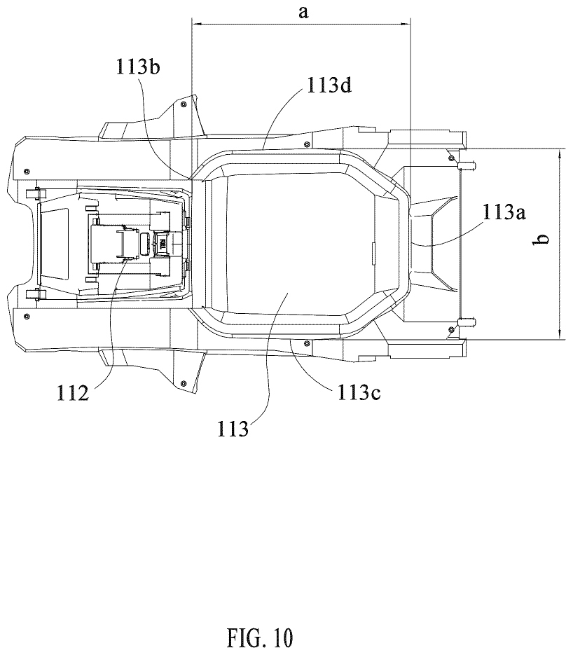

The horizontal distance a between the foremost end 113a of the storage portion and the rearmost end 113b of the storage portion is greater than or equal to 200 mm and less than or equal to 500 mm. In FIG. 10, a represents the horizontal distance between the foremost end 113a of the storage portion and the rearmost end 113b of the storage portion.

The storage portion 113 has a leftmost end 113c of the storage portion and a rightmost end 113d of the storage portion, and a horizontal distance b between the leftmost end 113c of the storage portion and the rightmost end 113d of the storage portion is greater than or equal to 150 mm and less than or equal to 400 mm. In FIG. 10, b represents the horizontal distance between the leftmost end 113c of the storage portion and the rightmost end 113d of the storage portion.

The storage portion 113 has the rearmost end 113b of the storage portion, and a projection of the rearmost end 113b of the storage portion on the ground is located behind the second projection P2. Thus, the storage portion 113 has a relatively large length on the body 110 to make full use of space in an upper portion of the body 110. The rearmost end 113b of the storage portion does not exceed a rearmost end of the rear walking wheels 132 to ensure the balance of the whole machine.

In some examples, the storage portion 113 includes one storage region which is relatively large and can accommodate a relatively large article. In some examples, the storage portion 113 includes at least two storage regions, and adjacent storage regions are separated by a barrier portion. Since the storage regions are separated from each other, different articles may be placed in different regions as required.

Part of the body 110 is recessed downward to form the storage portion 113, or a housing is connected to the body 110 to form the storage portion 113. The body 110 includes the deck 111 and a machine cover 114 disposed at least partially over the deck 111. The motor 142 is disposed between the deck 111 and the machine cover 114, and components such as wires and a controller are further disposed in a space enclosed between the machine cover 114 and the deck 111. The machine cover 114 protects these components. In this example, the machine cover 114 is formed with the storage portion 113. The machine cover 114 is sunk to form the storage portion 113 so that no new component needs to be added, the structure is simplified, and the space in the upper portion of the body 110 is fully utilized.

The coupling portion 112 can accommodate the energy device 150. In this example, the machine cover 114 is formed with the coupling portion 112, ensuring integrity and facilitating machining and production. In other examples, a detachable coupling portion 112 may be disposed. The machine cover 114 is sunk to form an accommodation cavity serving as the coupling portion 112 to accommodate the energy device 150. A cover 1121 may be disposed over the cavity to shield the energy device 150 and prevent dust from contaminating the energy device 150. An end of the cover 1121 is rotatably connected to the machine cover 114, and the other end of the cover 1121 is engaged with the machine cover 114 so that it is convenient to open the cover 1121 and take out or put in the energy device 150.

The energy device 150 may be inserted into the coupling portion 112 along the vertical direction or a horizontal direction. In this example, an acute angle exists between a direction in which the energy device 150 is inserted and pulled out and a horizontal plane to reduce the height of the whole machine.

The energy device 150 has a foremost end 150a of the energy device, and the distance between the foremost end 150a of the energy device and the foremost end 110a of the body is greater than or equal to 50 mm and less than or equal to 250 mm. In the drawings, c represents the distance between the foremost end 150a of the energy device and the foremost end 110a of the body. In some examples, the distance between the foremost end 150a of the energy device and the foremost end 110a of the body is greater than or equal to 80 mm and less than or equal to 150 mm. In some examples, the distance between the foremost end 150a of the energy device and the foremost end 110a of the body is greater than or equal to 100 mm and less than or equal to 120 mm.

In this example, the foremost end 150a of the energy device is located behind the foremost end 110a of the body. In other examples, the foremost end 150a of the energy device may be located before the foremost end 110a of the body.

The motor 142 is configured to rotate around a motor axis O1, the energy device 150 has a rearmost end 150b of the energy device, the rearmost end 150b of the energy device is located before the motor axis O1, and the distance between the rearmost end 150b of the energy device and the motor axis O1 is greater than or equal to 5 mm and less than or equal to 200 mm. In the drawings, e represents the distance between the rearmost end 150b of the energy device and the motor axis O1. In some examples, the distance between the rearmost end 150b of the energy device and the motor axis O1 is greater than or equal to 20 mm and less than or equal to 150 mm. In some examples, the distance between the rearmost end 150b of the energy device and the motor axis O1 is greater than or equal to 50 mm and less than or equal to 120 mm. In some examples, the distance between the rearmost end 150b of the energy device and the motor axis O1 is greater than or equal to 80 mm and less than or equal to 200 mm. The rearmost end 150b of the energy device is located before the motor axis O1, and the energy device 150 is positioned forward to provide more space for the storage portion 113 so that the storage portion 113 increases in volume and can store larger articles and more articles. The energy device 150 has a relatively large weight. The energy device 150 is moved forward so that the center of gravity of the mower 100 moves forward, and the mower 100 has further improved stability and use comfort.

In some examples, at least part of the storage portion 113 includes a drain channel 1132 configured to guide water in the storage portion 113 to flow out. During raining or cleaning, water is not easy to accumulate in the storage portion 113. A shape of the drain channel and the number of drain channels are not limited, the drain channel may be strip-shaped or hole-shaped, and one or more drain channels may be provided. In some examples, a plug may be disposed at an end of the drain channel to conveniently block the drain channel.

In some examples, an upper cover 115 is disposed over the storage portion 113, and the upper cover 115 enables the accommodation space of the storage portion 113 to be opened or closed. The upper cover can not only protect the article in the storage portion 113 but also prevent impurities such as dust from contaminating the accommodation space. The upper cover is engaged with the machine cover 114. Alternatively, an end of the upper cover is rotatably connected to the machine cover 114, and the other end of the upper cover is engaged with the machine cover 114. The upper cover is not considered as part of the storage portion 113. Therefore, the first projection P1 of the storage portion 113 on the ground does not include a projection of the upper cover. The upper cover may be larger than the storage portion 113, or the upper cover shields only part of the storage portion 113.

The storage portion 113 shown in FIGS. 1 to 10 is integrally formed with the machine cover 114 and not easy to detach. In some examples, at least part of the storage portion 113 is movable so that articles in the storage portion 113, such as weeds, leaves, water, or garbage, are easy to dump. In some examples, the storage portion 113 is rotatable to facilitate dumping and cleaning. In some examples, the storage portion 113 is detachable to facilitate dumping, cleaning, and replacement.

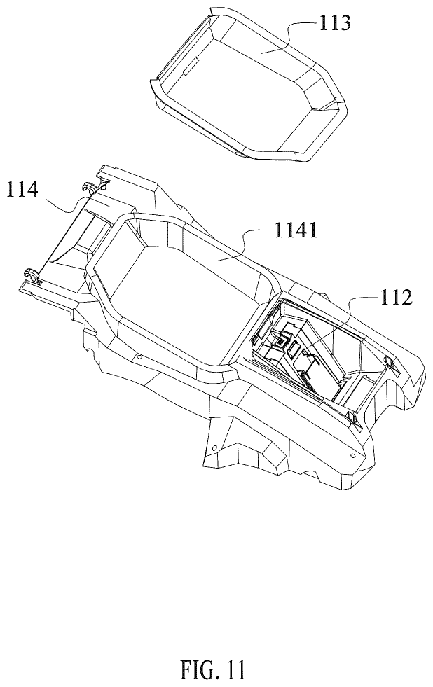

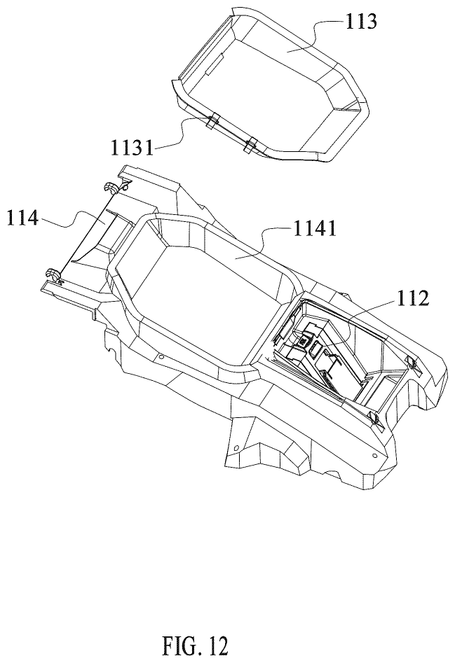

Referring to FIGS. 11 and 12, the machine cover 114 is sunk to form a mounting portion 1141, and the storage portion 113 is movably disposed in the mounting portion 1141. As shown in FIG. 11, the storage portion 113 is inserted into the mounting portion 1141. Since the mounting portion 1141 is disposed on an upper portion of the machine cover 114 and recessed downward, the storage portion 113 can be limited by inner walls or edges of the mounting portion 1141. When installed, the storage portion 113 is inserted downward into the mounting portion 1141. When detached, the storage portion 113 is lifted upward. As shown in FIG. 12, an end of the storage portion 113 is rotatably connected to the mounting portion 1141, and the storage portion 113 is inserted into the mounting portion 1141. When dumping is required, the storage portion 113 is just rotated. As shown in FIG. 12, a spindle 1131 is disposed on the right side of the storage portion 113 and the storage portion 113 is rotatably connected to the machine cover 114 through the spindle 1131.

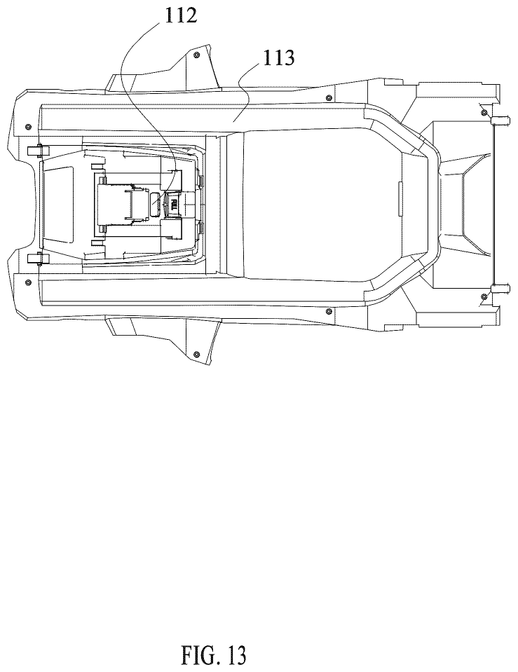

In the mower 100 shown in FIGS. 1 to 12, the storage portion 113 is entirely disposed on the rear side of the coupling portion 112. In some examples, part of the storage portion 113 is disposed on the rear side of the coupling portion 112, and at least part of the storage portion 113 is distributed on the left side or the right side of the coupling portion 112 to make full use of space around the coupling portion 112. As shown in FIG. 13, part of the storage portion 113 is disposed on the rear side of the coupling portion 112, and part of the storage portion 113 is distributed on the left side and the right side of the coupling portion 112.

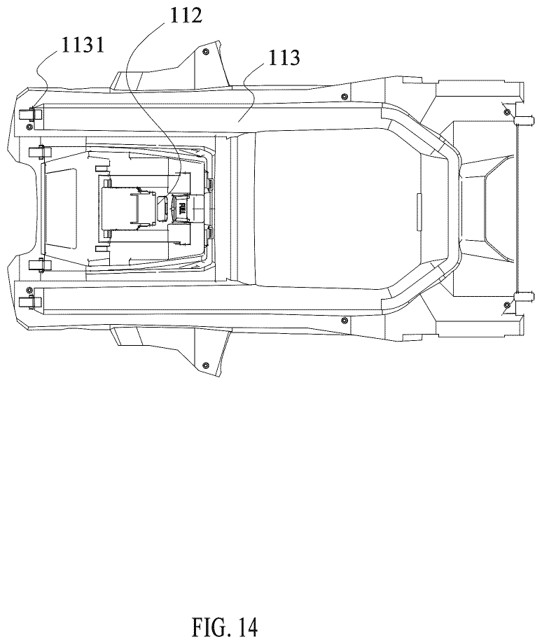

As shown in FIG. 14, when at least part of the storage portion 113 is distributed on the left side or the right side of the coupling portion 112, the storage portion 113 is rotatably connected to the machine cover 114. Specifically, the spindle 1131 may be disposed at the front end of the storage portion 113 and the storage portion 113 is rotatably connected to the machine cover 114 through the spindle 1131. When dumping is required, the storage portion 113 is just rotated.

The storage portion 113 and the coupling portion 112 may be integrated or disposed separately.

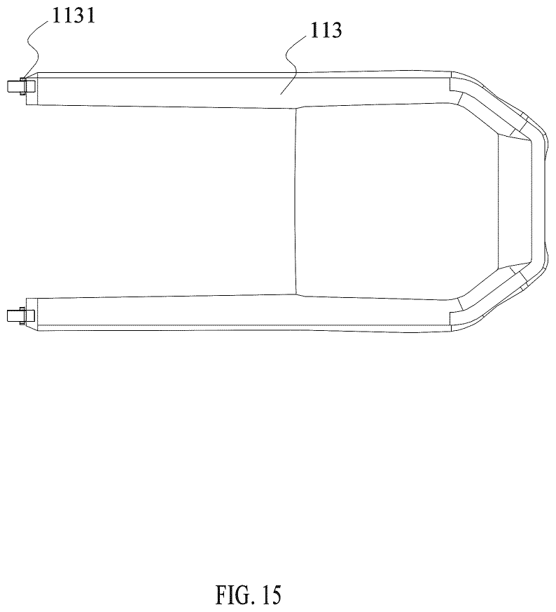

When the storage portion 113 and the coupling portion 112 are disposed separately, in the case where the storage portion 113 is rotatably connected to the machine cover 114, the storage portion 113 needs to be prevented from interfering with the coupling portion 112. As shown in FIG. 15, the storage portion 113 is basically U-shaped to avoid the coupling portion 112. When dumping is required, the storage portion 113 is rotated and the coupling portion 112 remains fixed.

When the storage portion 113 and the coupling portion 112 are integrated, in the case where the storage portion 113 is rotatably or detachably connected to the machine cover 114, the coupling portion 112 moves with the storage portion 113 when dumping is required. When the storage portion 113 is reset after dumping, the coupling portion 112 is reset. It is to be understood that when the coupling portion 112 moves with the storage portion 113, the energy device 150 in the coupling portion 112 is driven to move together. Therefore, it needs to be ensured that the energy device 150 can supply power normally after being moved. Generally, a wire needs to increase in length.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A walk-behind power tool, comprising:
a working assembly comprising a working member and a motor configured to drive the working member to rotate;
a body configured to accommodate at least part of the working assembly;
a handle device connected to the body; and
an energy device configured to provide energy for the motor;
wherein the body comprises a coupling portion configured to accommodate the energy device and a storage portion configured to store an article, the body has a foremost end of the body, at least part of the coupling portion is disposed between the foremost end of the body and the storage portion, a projection of the storage portion on the ground is defined as a first projection, a projection of the working member in rotation on the ground is defined as a second projection, and at least part of the first projection overlaps the second projection.

2. The walk-behind power tool of claim 1, wherein an overlapping portion between the first projection and the second projection is defined as a third projection, and an area ratio of the third projection to the first projection is greater than or equal to 0.5 and less than or equal to 1.

3. The walk-behind power tool of claim 1, wherein a projection of the coupling portion on the ground is defined as a fourth projection, and an area ratio of the fourth projection to the first projection is greater than or equal to 0.3 and less than or equal to 2.

4. The walk-behind power tool of claim 3, wherein an overlapping portion between the fourth projection and the second projection is defined as a fifth projection, and an area ratio of the fifth projection to the second projection is greater than or equal to 0 and less than or equal to 0.2.

5. The walk-behind power tool of claim 1, wherein at least part of the storage portion has a continuous and smooth bottom surface, a projection of the bottom surface on the ground is defined as a sixth projection, and an area ratio of the sixth projection to the second projection is greater than or equal to 0.3 and less than or equal to 0.9.

6. The walk-behind power tool of claim 1, wherein the body comprises a deck and a machine cover disposed at least partially over the deck.

7. The walk-behind power tool of claim 6, wherein the machine cover is formed with the storage portion.

8. The walk-behind power tool of claim 6, wherein the machine cover is formed with the coupling portion.

9. The walk-behind power tool of claim 1, wherein the storage portion is formed with an accommodation space, the accommodation space has a maximum water storage depth, and a ratio of the maximum water storage depth to a length of a longest part of the first projection is greater than or equal to 0.1 and less than or equal to 0.3.

10. The walk-behind power tool of claim 1, wherein the storage portion is formed with an accommodation space, the accommodation space has a maximum water storage depth, and the maximum water storage depth is greater than or equal to 30 mm and less than or equal to 200 mm.

11. The walk-behind power tool of claim 1, wherein the energy device has a foremost end of the energy device, and a distance between the foremost end of the energy device and the foremost end of the body is greater than or equal to 50 mm and less than or equal to 250 mm.

12. The walk-behind power tool of claim 1, wherein the motor is configured to rotate around a motor axis, the energy device has a rearmost end of the energy device, the rearmost end of the energy device is located before the motor axis, and a distance between the rearmost end of the energy device and the motor axis is greater than or equal to 5 mm and less than or equal to 200 mm.

13. The walk-behind power tool of claim 1, wherein at least part of the storage portion is movable.

14. The walk-behind power tool of claim 1, wherein the storage portion comprises at least two storage regions, and adjacent storage regions are separated by a barrier portion.

15. The walk-behind power tool of claim 1, wherein the storage portion has a rearmost end of the storage portion, and a projection of the rearmost end of the storage portion on the ground is located behind the second projection.

16. The walk-behind power tool of claim 1, wherein an upper cover is disposed over the storage portion, and the upper cover enables an accommodation space of the storage portion to be opened or closed.

17. The walk-behind power tool of claim 1, wherein at least part of the storage portion comprises a drain channel configured to guide water in the storage portion to flow out.

18. A walk-behind power tool, comprising:
a working assembly comprising a working member and a motor configured to drive the working member to rotate;
a body configured to accommodate at least part of the working assembly;
a handle device connected to the body; and
an energy device configured to provide energy for the motor;
wherein the body comprises a coupling portion configured to accommodate the energy device and a storage portion configured to store an article, the body has a foremost end of the body, and in a front and rear direction, the foremost end of the body, the coupling portion, and the storage portion are arranged in sequence, and projections of the storage portion and the motor on the ground at least partially overlap.

19. The walk-behind power tool of claim 18, wherein a length of the storage portion in the front and rear direction is greater than or equal to 200 mm and less than or equal to 500 mm.

20. The walk-behind power tool of claim 18, wherein a length of the storage portion in a left and right direction is greater than or equal to 150 mm and less than or equal to 400 mm.
